(19) United States
(12) Patent Application Publication
(10) Pub. No.: US 2026/0090934 A1
(43) Pub. Date: Apr. 2, 2026

(54) POWER DRIVE WHEEL MECHANISM FOR PATIENT SUPPORT APPARATUS

(71) Applicant: Hill-Rom Services, Inc., Batesville, IN (US)

(72) Inventors: Omar H. Dozal, Rushville, IN (US); Martin D. Weiler, Batesville, IN (US)

(21) Appl. No.: 19/337,974

(22) Filed: Sep. 24, 2025

Related U.S. Application Data
(60) Provisional application No. 63/701,557, filed on Sep. 30, 2024.

(51) Int. Cl. A61G 7/08

(52) U.S. Cl. CPC A61G 7/08

(57) ABSTRACT

A power drive for a patient support apparatus comprises a wheel support, a powered wheel, and a deployment actuator. The wheel support is configured to be pivotably coupled to a frame member of the patient support apparatus. The wheel support includes a mechanical stop engageable with another portion of the power drive when the wheel support is in a retracted position.

### CROSS-REFERENCE TO RELATED APPLICATION

This application claims the benefit of U.S. Patent Application No. 63/701,557, filed Sep. 30, 2024, the entire disclosure of which is incorporated hereby reference in its entirety.

### BACKGROUND

The present disclosure is directed to a deployment mechanism for a power drive wheel for a patient support apparatus. More specifically, the present disclosure is directed to a deployment mechanism that employs a linkage that includes a lost-motions member and an over-travel limiter to prevent damage to portions of the deployment mechanism.

The use of power drive wheels to provide assistance for moving patient support apparatuses during movement between portions of a healthcare facility helps prevent injuries to caregivers from pushing heavy equipment. Effectively implementing such a power drive wheel presents some challenges. For example, it is important that the power drive wheel be retractable such that equipment that has to extend under the patient support apparatus has clearance. In some cases, a patient lift that uses a sling to lift a patient from the patient support apparatus may need to extend under patient support apparatus to provide stability. This requires that the area under the patient support apparatus be clear when not in transport mode.

Additionally, during transport mode, a patient support apparatus may encounter various discontinuities in the floor. In some cases, the patient support apparatus may be moved up a ramp which tends to cause variations in the separation between a central area where a power drive wheel is located and the underlying floor surface. This may cause the power drive wheel to lose traction and unexpectedly increase the load for a caregiver managing the transport. In other cases, the power wheel may be pushed upwardly by a portion of the ramp as the patient support apparatus engages a downgrade ramp. Still further, the patient support apparatus may also encounter discontinuities in the floor surface, such as threshold frames or an elevator floor that is discontinuous in from an adjacent floor. When the power wheel mechanism experiences a discontinuity that urges the power wheel mechanism upwardly, the power wheel mechanism may experience a mechanical shock that can damage components of the system.

Given these challenges, there is a continual need to improve the performance of a power wheel mechanism to provide sufficient downward force to provide traction over varying floor conditions, while also preventing damage to the power wheel mechanism when floor discontinuities provide a shock to the power wheel drive mechanism.

### SUMMARY

The present disclosure includes one or more of the features recited in the appended claims and/or the following features which, alone or in any combination, may comprise patentable subject matter.

According to a first aspect of the present disclosure, a power drive for a patient support apparatus comprises a wheel support, a powered wheel, and a deployment actuator. The wheel support is configured to be pivotably coupled to a frame member of the patient support apparatus. The wheel support includes a mechanical stop engageable with another portion of the power drive when the wheel support is in a retracted position. The powered wheel is supported on the wheel support and configured to, when engaged with a floor, rotate under power to move the patient support apparatus across the floor. The deployment actuator is operable to cause the wheel support to pivot relative to the floor to move the powered wheel into and out of engagement with the floor. The deployment actuator is configured to cause the mechanical stop to engage the portion of the power drive when the deployment actuator is in a fully retracted position. The stop is operable to prevent a force from being imparted to the deployment actuator when the wheel support engages an obstruction in the floor.

In some embodiments of the first aspect, the power drive may include a deployment shaft interposed between the deployment actuator and the wheel support, the mechanical stop of the wheel support engaging the deployment shaft.

In some embodiments of the first aspect, the power drive may further comprise a lost motion member interposed between the deployment actuator and the wheel support. The lost motion member may be operable to provide bias to the wheel support to maintain the powered wheel in engagement with the floor when the power drive is in a deployed position.

In some embodiments of the first aspect, the lost motion member includes a gas charged actuator.

In some embodiments of the first aspect, the wheel support pivots about a first axis and the deployment shaft pivots about a second axis, the second axis parallel to and spaced apart from the first axis.

In some embodiments of the first aspect, the power drive may further comprise a first cross-member. In some embodiments of the first aspect, the deployment shaft and the wheel support may be pivotably coupled to the first cross-member.

In some embodiments of the first aspect, the power drive may further comprise a second cross-member. In some embodiments of the first aspect, the deployment actuator may have a first end supported from the second cross-member and a second end coupled to the deployment shaft.

In some embodiments of the first aspect, the lost motion may have a first end coupled to the wheel support and a second end coupled to the deployment shaft.

According to a second aspect of the present disclosure, a patient support apparatus comprises a base frame, a wheel support, a powered wheel, and a deployment actuator. The base frame is supported on casters for moving the patient support apparatus over a floor. The wheel support is pivotably coupled to the base frame, the wheel support including a mechanical stop. The powered wheel is supported on the wheel support and configured to, when engaged with a floor, provide motion to move the patient support apparatus over the floor. The deployment actuator is operable to cause the wheel support to pivot relative to the floor to move the powered wheel into and out of engagement with the floor. The deployment actuator is also configured to cause the mechanical stop to engage to prevent a force from being imparted to the deployment actuator when the deployment actuator is retracted.

In some embodiments of the second aspect, the patient support apparatus may further comprise a deployment shaft interposed between the deployment actuator and the wheel support, the mechanical stop of the wheel support engaging the deployment shaft.

In some embodiments of the second aspect, the patient support apparatus may further comprise a lost motion member interposed between the deployment actuator and the wheel support. The lost motion member may be operable to provide bias to the wheel support to maintain the powered wheel in engagement with the floor when the power drive is in a deployed position.

In some embodiments of the second aspect, the patient support apparatus may further comprise the lost motion member may include a gas charged actuator.

In some embodiments of the second aspect, the wheel support pivots about a first axis and the deployment shaft pivots about a second axis, the second axis parallel to and spaced apart from the first axis.

In some embodiments of the second aspect, the patient support apparatus may further comprise a first cross-member extending between longitudinal rails of the base frame. In such embodiments, the deployment shaft and the wheel support may be pivotably coupled to the first cross-member.

In some embodiments of the second aspect, the patient support apparatus may further comprise a second cross-member extending between longitudinal rails of the base frame. In such embodiments, the deployment actuator may have a first end supported from the second cross-member and a second end coupled to the deployment shaft.

In some embodiments of the second aspect, the lost motion member may have a first end coupled to the wheel support and a second end coupled to the deployment shaft.

According to a third aspect of the present disclosure, a power drive for a patient support apparatus comprises a power drive frame, a deployment shaft, a deployment actuator, and a wheel support. The power drive frame includes a pair of longitudinal rails configured to engage longitudinal rails of a base frame of the patient support apparatus. The power drive frame also includes first and second cross-members extending laterally between the longitudinal rails. The first cross-member is configured to be positioned closer to a head end of the patient support apparatus than the second cross-member when the power drive frame engages the base frame of the patient support apparatus. The deployment shaft is rotatably coupled to the first cross-member of the power drive frame and pivotable about a first axis. The deployment actuator is pivotably coupled to the second cross-member at a first end and pivotable relative to the second cross-member about a second axis. The deployment actuator is pivotably coupled to the deployment shaft at a second end of the deployment actuator. The wheel support is pivotably coupled to the first cross-member of the power drive frame and pivotable about a third axis. Extension or retraction of the length of the deployment actuator causes rotation of the deployment shaft about the first axis, rotation of the deployment actuator about the second axis, and rotation of the wheel support about the third axis.

According some embodiments of the third aspect, the power drive may further comprise a mechanical stop of the wheel support that engages the deployment shaft when the deployment actuator is in a fully retracted position.

According some embodiments of the third aspect, the power drive may further comprise a lost motion member interposed between the deployment actuator and the wheel support. In such embodiment, the lost motion member may be operable to provide bias to the wheel support to maintain the powered wheel in engagement with the floor when the power drive is in a deployed position.

According some embodiments of the third aspect, the lost motion member includes a gas charged actuator.

According some embodiments of the third aspect, the first, second, and third axes are all parallel.

According some embodiments of the third aspect, the third axis is positioned vertically lower than the first axis.

According some embodiments of the third aspect, the second axis is positioned vertically lower than the first axis and vertically higher than the third axis.

According some embodiments of the third aspect, the power drive further comprises a powered wheel assembly including a motor and a wheel driven by the motor. The wheel assembly may be supported on the wheel support such that movement of the wheel support moves the wheel into and out of engagement with a floor supporting the patient support apparatus.

According some embodiments of the third aspect, the power drive further comprises a mechanical stop of the wheel support that engages the deployment shaft when the deployment actuator is in a fully retracted position.

According some embodiments of the third aspect, the wheel support may be pivotable about the third axis when the deployment actuator is in the deployed position without movement of the deployment shaft.

According some embodiments of the third aspect, the lost motion member may vary in length when the deployment actuator is the in the deployed position as the wheel of the powered wheel assembly encounters variations in the floor supporting the patient support apparatus.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a patient support apparatus including a power drive wheel mechanism according to the present disclosure;

FIG. 2 is a perspective view of a power drive of the present disclosure taken from above the power drive;

FIG. 3 is a perspective of the power drive of FIG. 2 taken from below the power drive;

FIG. 4 is a side view of the power drive of FIG. 2 showing a drive wheel in a fully retracted position;

FIG. 5 is a side view similar to FIG. 4, the drive wheel in a fully deployed position in FIG. 5;

FIG. 6 is a perspective view of the power drive of FIG. 2 taken from below the power drive;

FIG. 7 is a perspective view of a bracket of the power drive of FIG. 2;

FIG. 8 is a perspective view of a wheel support of the power drive of FIG. 2;

FIG. 9 is a perspective view of a pivot pin used with the wheel support of FIG. 8; and

FIG. 10 is a side view of a portion of the power drive of FIG. 2, FIG. 10 showing a stop of the wheel support of FIG. 8 engaged with a deployment shaft, the stop operable to prevent shocks from being transferred to a deployment actuator of the power drive.

### DETAILED DESCRIPTION

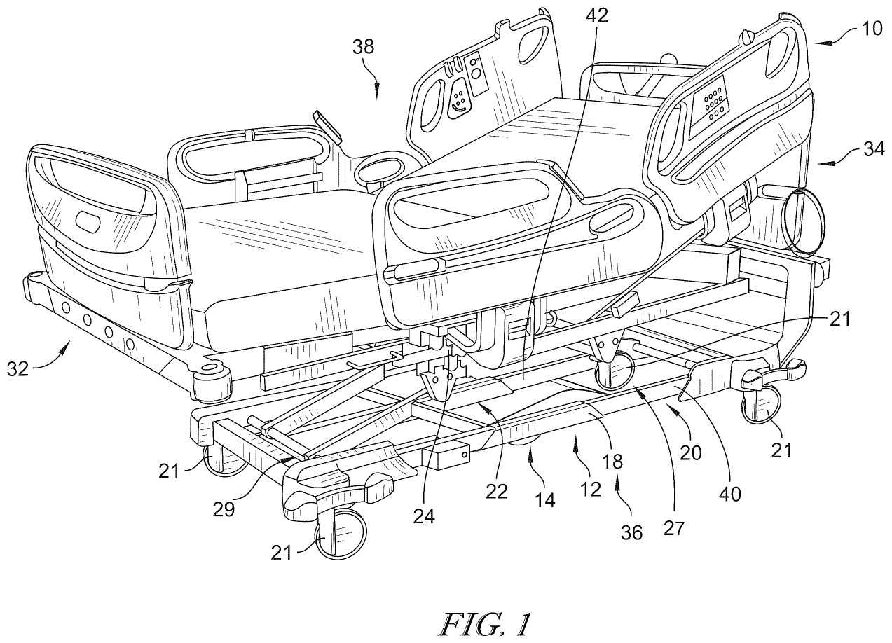

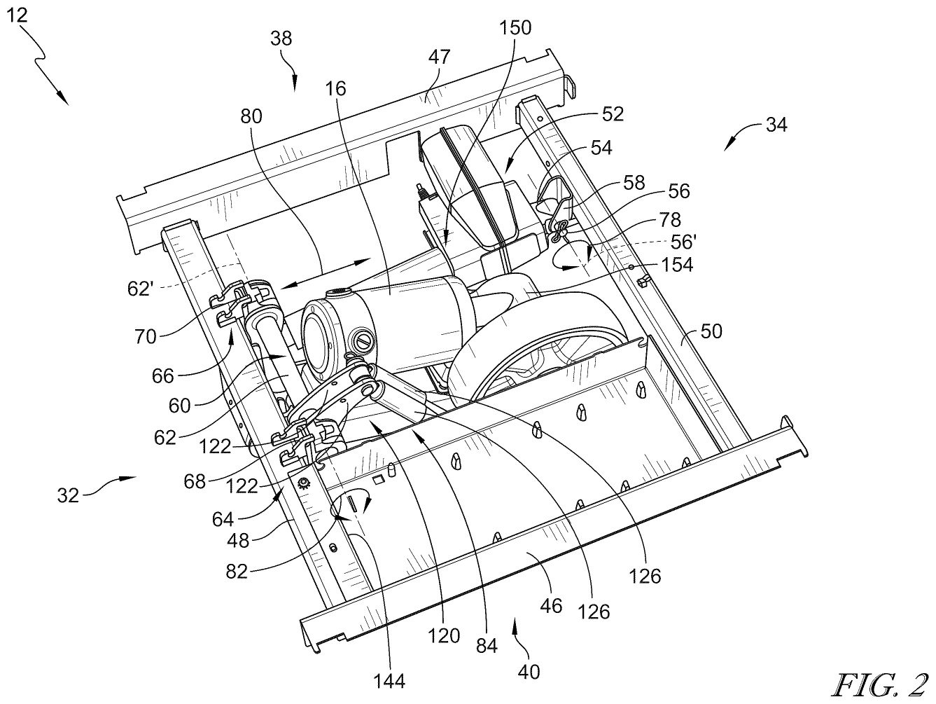

Referring to FIG. 1, a patient support apparatus 10, embodied as a hospital bed, includes various features including a power drive 12 that is used to assist a caregiver in moving the patient support apparatus 10 over a floor by driving a wheel 14 with a motor 16 (shown in FIG. 2). The approach of using a power drive 12 is known and discussed, for example, in U.S. Pat. No. 10,517,784, titled “PATIENT SUPPORT APPARATUS,” and issued on Dec. 31, 2019, which is incorporated herein for the disclosure of power drives used on patient support apparatuses, such as the power drive wheel assembly and other related components of that patent disclosed therein.

For purposes of orientation, the discussion of the hospital bed 10 will be based on the orientation of a patient supported on the hospital bed 10 in a supine position. Thus, the foot end 32 of the hospital bed 10 refers to the end nearest the patient's feet when the patient is supported on the hospital bed 10 in the supine position. The hospital bed 10 has a head end 34 opposite the foot end 32. A left side 36 refers to the patient's left when the patient is lying in the hospital bed 10 in a supine position. The right side 38 refers to the patient's right. When reference is made to the longitudinal length of the hospital bed 10, it refers a direction that is represented by the lines that generally extend between the head end 34 and foot end 32 of the hospital bed 10. Similarly, lateral width of the hospital bed 10 refers to a direction that is represented by the lines that generally extend between the left side 36 and right side 38.

The hospital bed 10 includes a base frame 20 supported on a number of casters 21 which allow the hospital bed 10 to be moved over a floor supporting the hospital bed 10. The base frame 20 supports a lift system 22. The lift system 22 engages the base and an upper frame 24 such that the lift system 22 moves the upper frame 24 vertically relative to the base frame 20. The lift system 22 includes a head end linkage 27 and a foot end linkage 29. Each of the linkages 27 and 29 are independently operable and may be operated to cause the hospital bed 10 to move into a tilt position which is when the head end 34 of the upper frame 24 is positioned lower than the foot end 32 of the upper frame 24. The hospital bed 10 may also be moved to a reverse tilt position with the foot end 32 of the upper frame 24 is positioned lower than the head end 44 of the upper frame 24.

The power drive 12 is supported from the base frame 20 which has longitudinal rails 40, 42 and is covered by a shroud 18. Referring now to FIG. 2, the power drive 12 includes a frame that has a pair of mounts 46, 47 which are positioned on the longitudinal rails 40, 42, respectively, when the power drive 12 is positioned on the base frame 20. The mounts 46, 47 are secured to a foot end cross-beam 48 and a head end cross-beam 50. A deployment actuator 52 is embodied as an electric actuator has a fixed end 54 that is pivotably mounted to the head end cross-beam 50 by a pin 56 that is secured to a bracket 58 mounted to the head end cross-beam 50 that that the deployment actuator 52 may pivot relative to the cross-beam 50. The pin 56 defines a pivot axis 56′ about which the deployment actuator 52 may pivot.

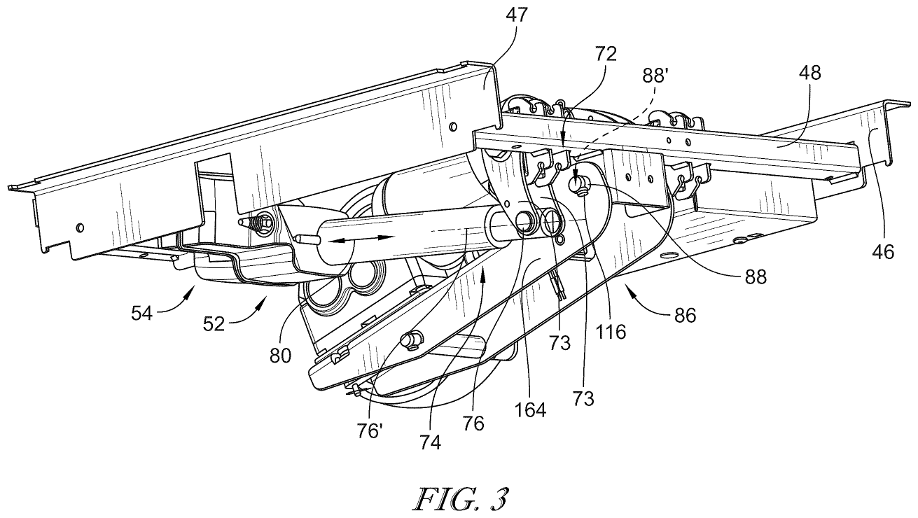

The deployment actuator 52 acts on a deployment shaft 60 that is pivotably mounted to the foot end cross-beam 48. The deployment shaft 60 includes a body 62 that is received in a pair of journal assemblies 64, 66, that are supported on the cross-beam 48 through a pair of brackets 68, 70, respectively. The body 62 defines a pivot axis 62′ about which the deployment shaft 60 rotates. Extension and retraction of the deployment actuator 52 is transferred to the deployment shaft 60 as the deployment actuator 52 acts on a crank assembly 72 which includes a pair of crank arms 73, 73 secured to the body 62 of the deployment shaft 60. A moving end 74 of the deployment actuator 52 extends and retracts relative to the fixed end 54 and is pivotably coupled to the crank assembly 72 by a pin 76 which defines a pivot axis 76′. Thus, when the moving end 74 extends or retracts relative to the fixed end 54, the distance between the pin 56 and the pin 76 varies and the deployment actuator 52 pivots about axis 56′ and the crank assembly 72 pivots relative to the pivot axis 76′ which moves in space as the moving end 74 moves relative to the fixed end 54. This results in some pivoting of the fixed end 54 about the pin 56 as indicated by arrow 78 in FIG. 2. The extension and retraction of the deployment actuator 52 results in the transfer of the linear motion indicated by arrow 80 to rotational motion of the deployment shaft 60 as indicated by arrow 82. The deployment actuator 52 moves between a fully retracted position shown in FIG. 2, to a fully deployed position, shown in FIG. 3.

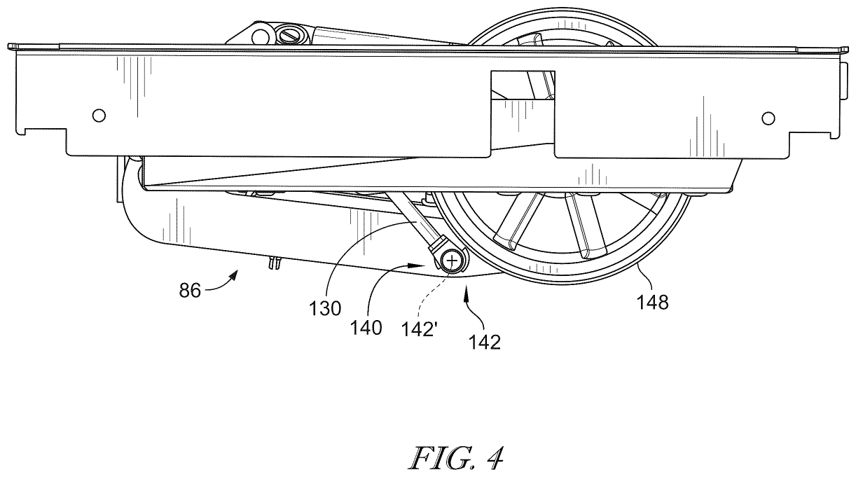

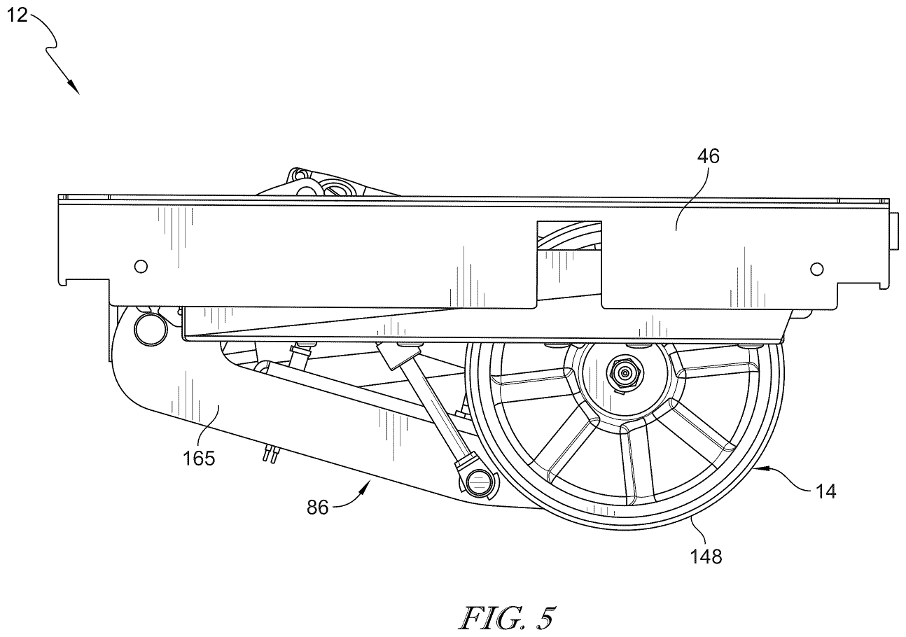

As will be discussed in further detail below, the movement of the deployment actuator 52 is transferred through the deployment shaft 60 to a lost motion assembly 84 which acts on a wheel support 86 to move the wheel support 86 between raised and lowered positions, the raised position shown in FIG. 4 and the lowered position shown in FIG. 5 and corresponding to a normal deployment of the power drive 12.

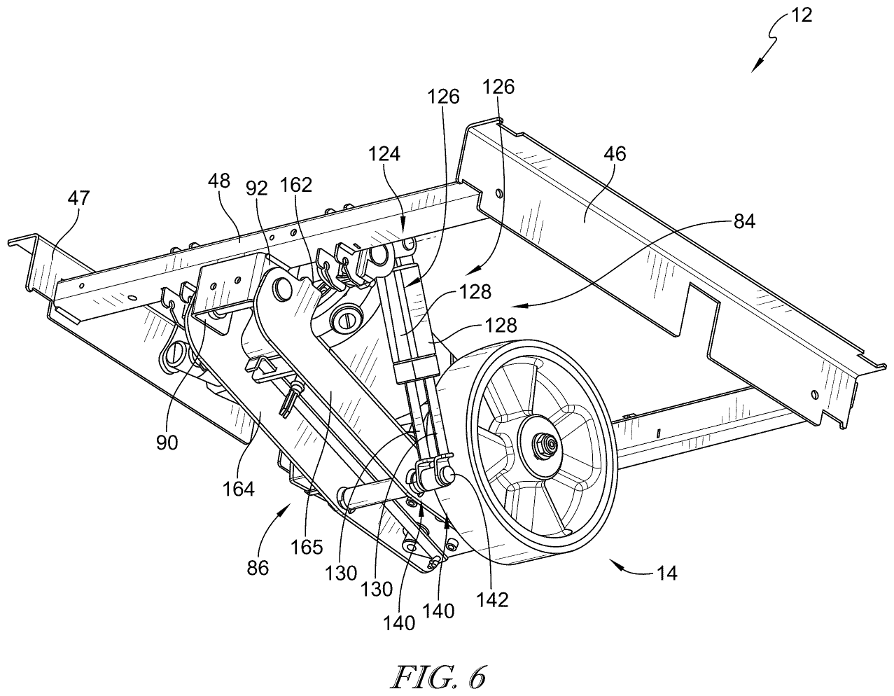

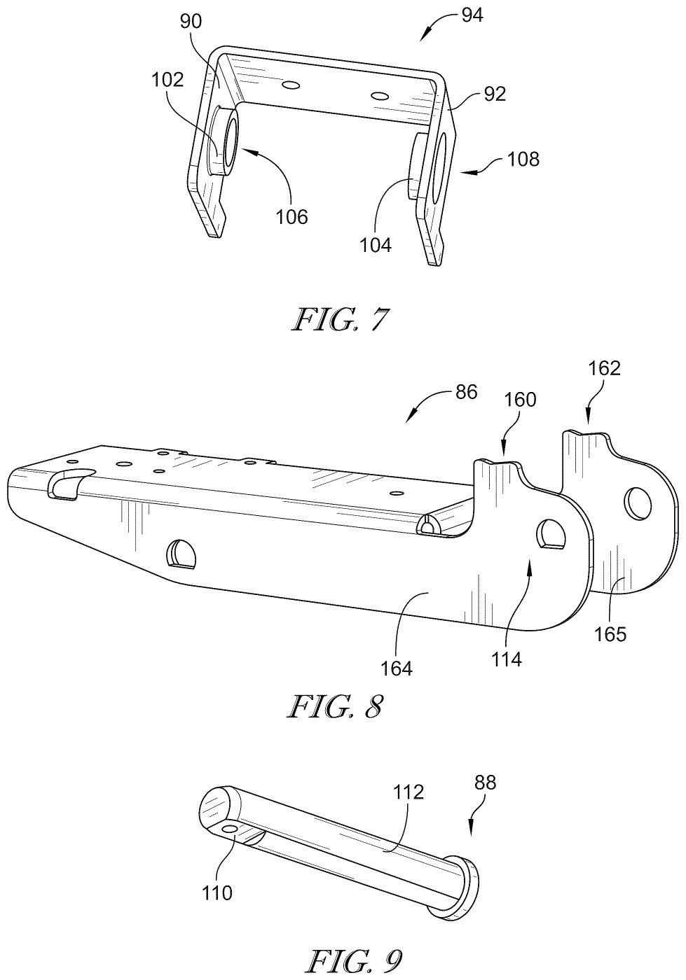

The wheel support 86 is pivotably supported from the foot end cross-beam 48 on a pivot pin 88 which defines a pivot axis 88′. The wheel support 86 is independently pivotable relative to the cross-beam 48. Once the lost motion assembly 84 is secured to the wheel support 86, movement of the lost motion assembly 84 acts on the wheel support 86 such that the wheel support 86 pivots about the axis 88′. Referring to FIG. 6, the pin 88 is supported on a pair of flanges 90, 92 of a pivot bracket 94 which is secured to the underside of the foot end cross-beam 48. Illustratively, the flanges 90, 92 are formed to include extruded bearings 102, 104 that are formed when a pair of holes 106, 108 are formed in the respective flanges 90, 92 as shown in FIG. 7. These extruded bearings 102, 104 provide journal surfaces for the pin 88. In the illustrative embodiment, the pivot bracket 94 and the pin 88 are electro-plated and the electro-plated surfaces engage without need for additional bearing material.

Referring to FIG. 8, the pin 88 is secured to the wheel support 86 by a flat 110 formed in the cylindrical body 112 of the pin 88. The flat 110 engages a corresponding cross-section of a hole 114 formed in a trailing arm 164 of the wheel support 86. In this way, the pin 88 is fixed to and moves with the wheel support 86, while pivoting relative to the pivot bracket 94, and, thereby, the cross-beam 48. A retaining screw 116 is positioned in the pin 88 to cause the pin 88 to be retained relative to the wheel support 86. It should be understood that, but for the control provided by the lost motion assembly 84, the wheel support 86 is free to move relative to the cross-beam 48.

The lost motion assembly 84 is secured to a second crank assembly 120 that includes two crank arms 122, 122 that are secured to the body 62 of the deployment shaft 60. The lost motion assembly 84 includes a pair of lost motion members 126, 126, that are secured for pivotable movement relative to the crank arms 122, 122 by a pin 124. The lost motion members 126, 126 are embodied as gas charged actuators with a cylinder 128 and a rod 130. The actuators 132 are biased to cause the rod 130 to extend from the cylinder 128 with a bias force. The rods 130 are shown fully extended when the power drive 12 is in the retracted position of FIGS. 2 and 4. The rod ends 140, 140 of the actuators 132, 132 are pivotably coupled to the wheel support 86 by a pin 142 which defines a pivot axis 142′.

During extension of the deployment actuator 52, the deployment shaft 60 rotates about the axis 62′ in the direction of arrow 144 and that rotational motion is transferred to the lost motion members 126, 126 by the crank arms 122, 122. This causes the lost motion members 126, 126 to act on the wheel support 86 to cause the wheel support 86 to pivot about the axis 88′. When the wheel support 86 pivots, a tread 148 of the wheel 14 engages the floor underlying the patient support apparatus 10. The deployment actuator 52 develops sufficient force to overcome the bias of the actuators 126, 126 to cause the rods 130, 130 to be displaced into the respective cylinders 128 with lost motion such that the bias of the actuators 126, 126 applies a load to the wheel support 86 and, thereby, the wheel 14 to cause the wheel 14 to be urged against the floor to maintain traction with the floor. Notably, the lost motion aspect of the actuators 126, 126 allows the wheel support 86 to move relative to the base frame 20 as discontinuities are encountered in the floor, maintaining sufficient contact to allow the wheel 14 the traction to continuously drive the patient support apparatus 10 over the floor.

It should be noted that the wheel 14 is supported from a motor assembly 150 that is mounted to the wheel support 86 so that the motor assembly 150 and wheel 14 move with the wheel support 86 as the wheel support 86 pivots about the axis 88′. The motor assembly 150 includes the motor 16 and a gearbox 154. The motor 152 is driven under the control of a power drive controller to control the speed of rotation of the wheel 14. The power drive controller receives inputs from a user, such as the approach disclosed in U.S. Pat. No. 10,517,784 incorporated by reference above.

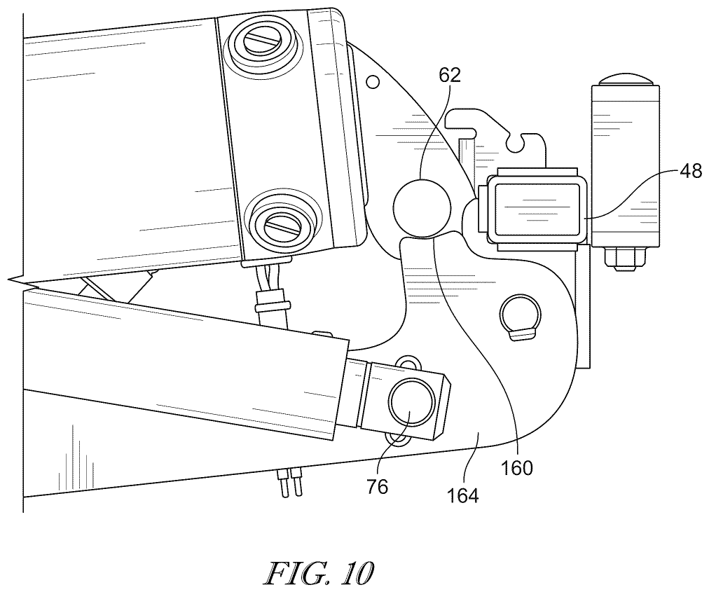

Referring now to FIG. 10, a portion of the power drive 12 is shown in the retracted position with the trailing arm 164 of the wheel support 86 having a stop 160 formed in the trailing arm, the stop positioned against the deployment shaft 60. The wheel support 86 includes the trailing arm 164 and another trailing arm 165, shown in FIG. 5, which each include respective stops 160, 162. In use, when the power drive 12 is in the retracted position, the stops 160, 162 rest against the body 62 of the deployment shaft 60. In this position, any shocks experienced by the wheel 14 or the trailing arms 164, 165 due to engagement with an obstruction, such as a floor threshold, are transferred through the wheel support 86 and limited by the engagement of the stops 160, 162 with the deployment shaft 60. As such, no motion is transferred to the deployment actuator 52. This prevents any damage to the deployment actuator 52 due to contact with obstructions as the stops 160, 162 absorb the load and transfer the force experienced through to the shaft 60 and, thereby, the base frame 20.

While the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

Although this disclosure refers to specific embodiments, it will be understood by those skilled in the art that various changes in form and detail may be made without departing from the subject matter set forth in the accompanying claims.

1. A power drive for a patient support apparatus comprising:
a wheel support configured to be pivotably coupled to a frame member of the patient support apparatus, the wheel support including a mechanical stop engageable with another portion of the power drive when the wheel support is in a retracted position;
a powered wheel supported on the wheel support, the powered wheel configured to, when engaged with a floor, rotate under power to move the patient support apparatus across the floor; and
a deployment actuator operable to cause the wheel support to pivot relative to the floor to move the powered wheel into and out of engagement with the floor, the deployment actuator configured to cause the mechanical stop to engage the portion of the power drive when the deployment actuator is in a fully retracted position, the stop operable to prevent a force from being imparted to the deployment actuator when the wheel support engages an obstruction in the floor.

2. The power drive of claim 1, wherein the power drive includes a deployment shaft interposed between the deployment actuator and the wheel support, the mechanical stop of the wheel support engaging the deployment shaft.

3. The power drive of claim 2, further comprising a lost motion member interposed between the deployment actuator and the wheel support, the lost motion member operable to provide bias to the wheel support to maintain the powered wheel in engagement with the floor when the power drive is in a deployed position.

4. The power drive of claim 3, wherein the lost motion member includes a gas charged actuator.

5. The power drive of claim 1, wherein the power drive includes a deployment shaft interposed between the deployment actuator and the wheel support, the mechanical stop of the wheel support engaging the deployment shaft.

6. The power drive of claim 5, wherein the wheel support pivots about a first axis and the deployment shaft pivots about a second axis, the second axis parallel to and spaced apart from the first axis.

7. The power drive of claim 6, wherein the power drive further comprises a first cross-member, the deployment shaft and the wheel support being pivotably coupled to the first cross-member.

8. The power drive of claim 7, further comprising a lost motion member interposed between the deployment actuator and the wheel support, the lost motion member operable to provide bias to the wheel support to maintain the powered wheel in engagement with the floor when the power drive is in a deployed position.

9. The power drive of claim 8, where the power drive further comprises a second cross-member, the deployment actuator having a first end supported from the second cross-member and a second end coupled to the deployment shaft.

10. The power drive of claim 9, wherein the lost motion member has a first end coupled to the wheel support and a second end coupled to the deployment shaft.

11. The power drive of claim 2, wherein the power drive further comprises a first cross-member, the deployment shaft and the wheel support being pivotably coupled to the first cross-member.

12. A patient support apparatus comprising:
a base frame supported on casters for moving the patient support apparatus over a floor;
a wheel support pivotably coupled to the base frame, the wheel support including a mechanical stop;
a powered wheel supported on the wheel support, the powered wheel configured to, when engaged with a floor, provide motion to move the patient support apparatus over the floor; and
a deployment actuator operable to cause the wheel support to pivot relative to the floor to move the powered wheel into and out of engagement with the floor, the deployment actuator configured to cause the mechanical stop to engage to prevent a force from being imparted to the deployment actuator when the deployment actuator is retracted.

13. The patient support apparatus of claim 12, further comprising a deployment shaft interposed between the deployment actuator and the wheel support, the mechanical stop of the wheel support engaging the deployment shaft.

14. The patient support apparatus of claim 13, further comprising a lost motion member interposed between the deployment actuator and the wheel support, the lost motion member operable to provide bias to the wheel support to maintain the powered wheel in engagement with the floor when the powered wheel is in a deployed position.

15. The patient support apparatus of claim 14, wherein the lost motion member includes a gas charged actuator.

16. The patient support apparatus of claim 15, further comprising a deployment shaft interposed between the deployment actuator and the wheel support, the mechanical stop of the wheel support engaging the deployment shaft.

17. The patient support apparatus of claim 16, wherein the wheel support pivots about a first axis and the deployment shaft pivots about a second axis, the second axis parallel to and spaced apart from the first axis.

18. The patient support apparatus of claim 16, further comprising a first cross-member extending between longitudinal rails of the base frame, the deployment shaft and the wheel support being pivotably coupled to the first cross-member.

19. The patient support apparatus of claim 18, wherein the lost motion member has a first end coupled to the wheel support and a second end coupled to the deployment shaft.

20. The patient support apparatus of claim 12, further comprising a first cross-member extending between longitudinal rails of the base frame and a deployment shaft interposed between the deployment actuator and the wheel support, the mechanical stop of the wheel support engaging the deployment shaft, the deployment shaft and the wheel support being pivotably coupled to the first cross-member.
